(19) United States
(12) Patent Application Publication
(10) Pub. No.: US 2016/0162665 A1
(43) Pub. Date: Jun. 9, 2016

(54) METHOD FOR SELECTING SOLVENT FOR SOLUTION PROCESS USING SOLVENT GROUP INDEX AND SYSTEM USING SAME

(71) Applicant: LG CHEM, LTD., Seoul (KR)

(72) Inventors: Seungyup LEE, Daejeon (KR); Jiehyun SEONG, Daejeon (KR); Kyounghoon KIM, Daejeon (KR)

(21) Appl. No.: 14/906,117

(22) PCT Filed: Aug. 12, 2014
(86) PCT No.: PCT/KR2014/007467

§ 371 Date: Jan. 19, 2016

(30) Foreign Application Priority Data
Aug. 22, 2013 (KR) 10-2013-0099573

(51) Int. Cl. G06F 19/00

(52) U.S. Cl. CPC G06F 19/704

(57) ABSTRACT

The present invention relates to a method of selecting a solvent for solution process, and a system using the same. More particularly, the present invention relates to a method of selecting a solvent for solution process which can discriminate two or more solvents that exhibit different performance when they are applied to solution process, but which are difficult to discriminate with the conventional assessing method using Hansen Solubility Parameter (HSP).

### TECHNICAL FIELD

The present invention relates to a method of selecting a solvent for solution process, and a system using the same. More particularly, the present invention relates to a method of selecting a solvent for solution process which can discriminate two or more solvents that exhibit different performance when they are applied to solution process, but which are difficult to discriminate with the conventional assessing method using Hansen Solubility Parameter (hereinafter referred to as “HSP”).

### BACKGROUND ART

A solution process for material production is more frequently used than other methods, such as deposition, because it is relatively simple, physical properties are easily controlled, and production cost is very low. One of the most important factors, upon which the performance of the solvent process is dependent, is the solvent used. For example, a coating process, which is a solution process, employs a coating solution prepared by dissolving a material to be applied as a coating (for the most part, a polymer resin) in a solvent; and its coating performance greatly depends on the property of the solvent. The accurate evaluation of solvent properties is essential to the selection of a solvent optimal for preparing a solution capable of improving the performance of a solution process.

To assess solubility or miscibility among different materials, intrinsic properties of them should be analyzed for similarity. There are various intrinsic properties that have effects on solubility or miscibility. Inter alia, solubility parameters, which express interaction between materials as quantitative values, are most common. That is, materials have respective intrinsic solubility parameters, and are well dissolved or miscible together if their solubility parameter values are similar.

Solubility parameters have been proposed and used on the basis of various theories and concepts. Among them, the Hansen Solubility Parameter (hereinafter referred to as “HSP), developed by Dr. C. Hansen in 1967, is known to represent solubility properties most accurately. In the HSP, interaction between materials is considered in terms of the following three solubility parameters:

(1) solubility parameter generated by non-polar dispersion energy (δD)

(2) solubility parameter generated by polar energy due to a permanent dipole moment (δP)

(3) solubility parameter generated by energy within hydrogen bonds (δH)

As such, the HSP is widely used because it can provide information on intermolecular interaction in greater detail and thus can evaluate solubility or miscibility between materials more accurately and systemically than other solubility parameters.

HSP=(δD,δP,δH),(J/cm³)^{1/2} (1)

δTot=(δD²+δP²+δH²)^{1/2},(J/cm³)^{1/2} (2)

The HSP represents vector properties with magnitude and direction in the Hansen space defined by the three parameters as coordinates while δTot represents the magnitude of HSP vector. HSP is measured in (J/cm³)^{1/2}. These HSP values can be calculated using the program HSPiP (Hansen Solubility Parameters in Practice) developed by the Dr Hansen Group.

As mentioned above, two different materials are soluble with respect to each other when they are similar in HSP. Since HSP is a vector, the necessary condition for determining the similarity of HSP between two materials is that all the three HSP elements must be similar in magnitude and direction therebetween. Every material has its intrinsic HSP, and two different materials are miscible when they are similar in HSP. Like other solubility parameters, HSP was proposed on the concept that ‘a like likes a like.’

However, even when two or more different solvents that are evaluated to have almost the same property as assessed by HSP, which is known to most accurately predict material properties, are applied to a solution process; the performance of the solution process may greatly vary depending on the solvents. For example, when solutions of material C in solvents A and B that have almost the same HSP are used, the performance of the solution process may be better with solvent A than solvent B.

In order to enhance the performance of solution process, it is necessary to discriminate solvents A and B more precisely in terms of process performance even though they are the same in HSP. As seen in HSP, conventional methods have difficulty in precisely discriminating properties between solvents A and B which have similar properties. The necessity that arises from the limitation of HSP in discriminating solvent properties has inspired the present inventor to develop a method of selecting a solvent for solution process by which two or more solvents can be precisely discriminated amongst in terms of property.

### DISCLOSURE

### Technical Problem

Accordingly, the present invention has been made keeping in mind the above problems occurring in the prior art, and an object of the present invention is to provide a novel method of selecting a solvent for solution process wherein two or more populations of solvents are evaluated for characteristics, the solvents are again assigned to new populations using the difference of HSP, and the solvents are discriminated using property differences between new populations.

### Technical Solution

In accordance with an aspect of the present invention to accomplish the above object, there is provided

In order to accomplish the above objects, the present invention provides a method of selecting a solvent for solution process, the method comprising:

1) calculating DEV-HSP (A_{I},B_{J}), which is the Hansen Solubility Parameter deviation between solvent A_{I} that amounts to the number N₁ and belongs to population A, and solvent B_{J} that amounts to the number N₂ and belongs to population B, according to the following equation 1;

2) determining which of the N₁×N₂ number combinations of A_{I} and B_{J} that are calculated for HSP deviation (DEV-HSP(A_{I},B_{J}) in step 1) has an HSP deviation value within the range of from zero (0) to ε (a real number greater than zero);

3) stopping the assessing process of solvent properties when none of the A_{I} and B_{J} combinations have an HSP deviation within the range defined in step 2), or if otherwise, assigning A_{I} and B_{J}, the DEV-HSP(A_{I},B_{J}) of which falls within the range, to populations A′ and B′, respectively;

4) calculating REP-HSP(M) for solvent M that belongs to the population A′ or B′ assigned in step 3) according to the following equation 2;

5) calculating Group-Score(M) for solvent M that belongs to the population A′ or B′ assigned in step 3) according to the following equation 3;

6) obtaining maximum and minimum values of each population from among the Group-Score(M) values calculated in step 5); and

7) discriminating populations A′ and B′ to assess difference in property between populations A′ and B′ with the help of the Group-Score(M) value if δ(A′,B′)>E or δ(B′,A′)>E as measured by the following equation 4:

DEV-HSP(A_{I},B_{J})=(a₁×|D(A_{I})−D(B_{J})|^{b}+a₂×|P(A_{I})−P(B_{J})|^{b}+a₃×|H(A_{I})−H(B_{J})|^{b})^{c} [Equation 1]

wherein A_{I} and B_{J} are solvents belonging to populations A and B, respectively, the HSP of solvent A_{I} is expressed as HSP=(D(A_{I}),P(A_{I}),H(A_{I})) wherein D(A_{I}) is a solubility parameter generated by non-polar dispersion, P(A_{I}) is a solubility parameter generated by polar energy due to a permanent dipole moment, H(A_{I}) is a solubility parameter generated by energy within hydrogen bonds, a₁, a₂, and a₃ each represent a real number greater than zero (0), b is a real number greater than zero (0), and c is a real number greater than zero (0);

REP-HSP(M)=(x₁×D(M)^{y}+x₂×P(M)^{y}+x₃×H(M)^{y})^{z} [Equation 2]

wherein the HSP of solvent M is expressed as HSP=(D(M), P(M), H(M)) wherein D(M) is a solubility parameter generated by non-polar dispersion, P(M) is a solubility parameter generated by polar energy due to a permanent dipole moment, H(M) is a solubility parameter generated by energy of hydrogen bonds, x1, x2, and x3 each represent a real number greater than zero (0), y is a real number greater than zero (0), and z is a real number greater than zero (0);

Group-Score(M)=Funct1(REP-HSP(M))×Funct2(PC(M)) [Equation 3]

wherein Funct1(x)=γ×{ log_{β}(x)}^{α} wherein α is a real number greater than 0.5, β is a real number greater than 0 and γ is a real number greater than 0, and Funct2(x)=d^{x} or d^{-x} wherein d is a real number greater than 0.01, PC(M) is an octanol-water partition coefficient obtained by experimental measurement or by theoretical calculation, or topological polar surface area obtained by theoretical calculation; and

δ(A′,B′)=MIN(A′)−MAX(B′)

δ(B′,A′)=MIN(B′)−MAX(A′) [Equation 4]

wherein MAX(A′) and MIN(A′) represent maximum and minimum values among the Group-score values calculated for the solvents belonging to population A′, respectively; and MAX(B′) and MIN(B′) represent maximum and minimum values among the Group-Score values calculated for the solvents belonging to population B′, respectively.

In addition, the present invention provides a system of selecting a solvent for a solution process, comprising:

a first data input module for receiving data obtained by calculating DEV-HSP (A_{I},B_{J}), which is the Hansen Solubility Parameter deviation between solvent A_{I} that amounts to the number N₁ and belongs to population A, and solvent B_{J} that amounts to the number N₂ and belongs to population B, according to the following equation 1;

a second data input module for receiving data obtained by determining which combination of the N₁×N₂ number combinations of A_{I} and B_{J} that are calculated for HSP deviation (DEV-HSP(A_{I},B_{J}) in step 1) has an HSP deviation value within the range of from zero (0) to ε (a real number greater than zero);

a third data input module for receiving data obtained by stopping the assessing process of solvent properties when none of the A_{I} and B_{J} combinations have an HSP deviation within the range defined in the second data input module, or by assigning, if otherwise, A_{I} and B_{J}, the DEV-HSP(A_{I},B_{J}) of which falls within the range, to populations A′ and B′, respectively;

a fourth data input module for receiving data obtained by calculating REP-HSP(M) for solvent M that belongs to the population A′ or B′ assigned in the third data input module according to the following equation 2;

a fifth data input module for receiving data obtained by calculating Group-Score(M) for solvent M that belongs to the population A′ or B′ assigned in the third data input module according to the following equation 3;

a sixth data input module for receiving data on maximum and minimum values of each population obtained from among the Group-Score(M) values calculated in the fifth data input module; and

an assessment module for receiving data obtained by discriminating populations A′ and B′ to assess difference in property between populations A′ and B′ with the help of the Group-Score(M) value if δ(A′,B′)>E or δ(B′,A′)>E as measured by the following equation 4:

DEV-HSP(A_{I},B_{J})=(a₁×|D(A_{I})−D(B_{J})|^{b}+a₂×|P(A_{I})−P(B_{J})|^{b}+a₃×|H(A_{I})−H(B_{J})|^{b})^{c} [Equation 1]

wherein A_{I} and B_{J} are solvents belonging to populations A and B, respectively, the HSP of solvent A_{I} is expressed as HSP=(D(A_{I}),P(A_{I}),H(A_{I})) wherein D(A_{I}) is a solubility parameter generated by non-polar dispersion, P(A_{I}) is a solubility parameter generated by polar energy due to a permanent dipole moment, H(A_{I}) is a solubility parameter generated by energy within hydrogen bonds, a₁, a₂, and a₃ each represent a real number greater than zero (0), b is a real number greater than zero (0), and c is a real number greater than zero (0);

REP-HSP(M)=(x₁×D(M)^{y}+x₂×P(M)^{y}+x₃×H(M)^{y})^{z} [Equation 2]

wherein the HSP of solvent M is expressed as HSP=(D(M), P(M), H(M)) wherein D(M) is a solubility parameter generated by non-polar dispersion, P(M) is a solubility parameter generated by polar energy due to a permanent dipole moment, H(M) is a solubility parameter generated by energy within hydrogen bonds, x₁, x₂, and x₃ each represent a real number greater than zero (0), y is a real number greater than zero (0), and z is a real number greater than zero (0);

Group-Score(M)=Funct1(REP-HSP(M))×Funct2(PC(M)) [Equation 3]

wherein Funct1(x)=γ×{ log_{β}(x)}^{α} wherein α is a real number greater than 0.5, β is a real number greater than 0 and γ is a real number greater than 0, and Funct2(x)=d^{x} or d^{-x} wherein d is a real number greater than 0.01, PC(M) is an octanol-water partition coefficient obtained by experimental measurement or theoretical calculation or topological polar surface area obtained by theoretical calculation; and

δ(A′,B′)=MIN(A′)−MAX(B′)

δ(B′,A′)=MIN(B′)−MAX(A′) [Equation 4]

wherein MAX(A′) and MIN(A′) represent maximum and minimum values among the Group-score values calculated for the solvents belonging to population A′, respectively, and MAX(B′) and MIN(B′) represent maximum and minimum values among the Group-Score values calculated for the solvents belonging to population B′, respectively.

### Advantageous Effects

As described hitherto, the method of selecting a solvent for solution process in accordance with the present invention can discriminate two or more solvents that exhibit different performance when they are applied to solution process, but which are difficult to discriminate with the conventional assessing method using difference of HSP. Designed to precisely discriminate two or more solvents in terms of property according to process condition, the present invention can select optimal solvents for solution process, and thus is expected to have great utility in systemically evaluating mixtures.

### DESCRIPTION OF DRAWINGS

FIG. 1 is a concept view illustrating solvent property assessment of populations A and B, each composed of three solvents, in a stepwise manner.

FIG. 2 is a schematic view illustrating the discrimination of populations A′ and B′ using Group-Score.

### BEST MODE

Below, a detailed description will be given of the present invention.

In accordance with an aspect thereof, the present invention addresses a method of selecting a solvent for solution process, the method comprising:

1) calculating DEV-HSP (A_{I},B_{J}), which is the Hansen Solubility Parameter deviation between solvent A_{I} that amounts to the number N₁ and belongs to population A, and solvent B_{J} that amounts to the number N₂ and belongs to population B, according to the following equation 1;

2) determining which of the N₁×N₂ number combinations of A_{I} and B_{J} that are calculated for HSP deviation (DEV-HSP(A_{I},B_{J}) in step 1) has an HSP deviation value within the range of from zero (0) to ε (a real number greater than zero);

3) stopping the assessing process of solvent properties when none of the A_{I} and B_{J} combinations have an HSP deviation within the range defined in step 2), or if otherwise, assigning A_{I} and B_{J}, the DEV-HSP(A_{I},B_{J}) of which falls within the range, to populations A′ and B′, respectively;

4) calculating REP-HSP(M) for solvent M that belongs to the population A′ or B′ assigned in step 3) according to the following equation 2;

5) calculating Group-Score(M) for solvent M that belongs to the population A′ or B′ assigned in step 3) according to the following equation 3;

6) obtaining maximum and minimum values of each population from among the Group-Score(M) values calculated in step 5); and

7) discriminating populations A′ and B′ to assess difference in property between populations A′ and B′ with the help of the Group-Score (M) value if δ(A′,B′)>E or δ(B′,A′)>E as measured by the following equation 4.

In one exemplary embodiment, the same amount of a solute P1 is dissolved in each of an N₁ number of solvents (population A: A₁, A₂, . . . , A_{N1}), and an N₂ number of solvents (population B: B₁, B₂, . . . , B_{N2}), and the solutions are applied to a solution process. As a result, the assumption was made that desired process performance would be obtained with the solvents of population A, but not with the solvents of population B. Thus, properties of solvents of populations A and B are evaluated to maximize the process performance. Further, a method of selecting and preparing an optimal solvent by precisely discriminating populations A and B is conducted. In steps 1) to 3) of the method according to the present invention, an N₁ number of solvents of population A and an N₂ number of solvents of population B are evaluated for properties, and respectively assigned to populations A′ and B′, using HSP deviation therebetween.

Step 1) is to calculate DEV-HSP (A_{I},B_{J}), which is the Hansen Solubility Parameter deviation between solvent A_{I} that amounts to the number N₁ and belongs to population A, and solvent B_{J} that amounts to the number N₂ and belongs to population B, according to the following equation 1:

DEV-HSP(A_{I},B_{J})=(a₁×|D(A_{I})−D(B_{J})|^{b}+a₂×|P(A_{I})−P(B_{J})|^{b}+a₃×|H(A_{I})−H(B_{J})|^{b})^{c} [Equation 1]

wherein A_{I} and B_{J} are solvents belonging to populations A and B, respectively, the HSP of solvent A_{I} is expressed as HSP=(D(A_{I}),P(A_{I}),H(A_{I})) wherein D(A_{I}) is a solubility parameter generated by non-polar dispersion, P(A_{I}) is a solubility parameter generated by polar energy due to a permanent dipole moment, H(A_{I}) is a solubility parameter generated by energy within hydrogen bonds, a₁, a₂, and a₃ each represent a real number greater than zero (0), b is a real number greater than zero (0), and c is a real number greater than zero (0). In a preferred exemplary embodiment, a₁ is a real number ranging from 0.5 to 4.5, a₂ is a real number ranging from 0.5 to 3, a₃ is a real number ranging from 0.5 to 2.5, b is a real number ranging from 1.0 to 2.5, and c is a real number ranging from 0.1 to 1.0.

In greater detail, step 1) is carried out as shown in the following process:

```
DO I = 1, N₁
  DO J = 1, N₂
    DEV-HSP(A_{I}, B_{J}) = (a₁x|D(A_{I})−D(B_{J})|^{b}+a₂x|P(A_{I})−P(B_{J})|^{b}+
    a₃x|H(A_{I})−H(B_{J})|^{b})^{c}
  ENDDO
ENDDO
```

Step 2) is a step for determining which of the N₁×N₂ number of A_{I} and B_{J} combinations that are calculated for HSP deviation (DEV-HSP(A_{I},B_{J}) in step 1) has an HSP deviation value within the range of from zero (0) to c (a real number greater than zero). Preferably, c ranges from 0.1 to 4.0.

Step 3) is a step in which the assessing process of solvent properties is stopped when none of the A_{I} and B_{J} combinations have an HSP deviation within the range defined in step 2), or if otherwise, A_{I} and B_{J}, the DEV-HSP(A_{I},B_{J}) of which falls within the range, are assigned to populations A′ and B′, respectively.

In detail, because properties of the solvents can be precisely discriminated when the number of the combinations having an HSP deviation that falls within the range is zero, the process is stopped.

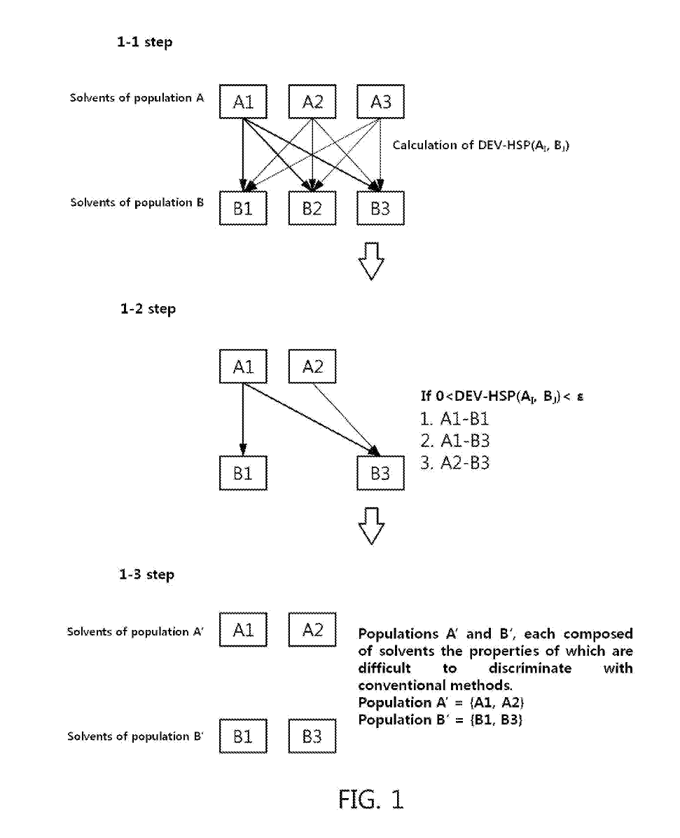

With reference to FIG. 1, solvent property assessment of populations A and B, each composed of three solvents, is illustrated in a stepwise manner described above.

In steps 4) to 7) of the method according to the present invention, solvents assigned to populations A′ and B′ in step 3) are discriminated using property differences between the populations.

Step 4) is to calculate REP-HSP(M) for solvent M that belongs to the population A′ or B′ assigned in step 3) according to the following equation 2;

REP-HSP(M)=(x₁×D(M)^{y}+x₂×P(M)^{y}+x₃×H(M)^{y})^{z} [Equation 2]

wherein the HSP of solvent M is expressed as HSP=(D(M), P(M), H(M)) wherein D(M) is a solubility parameter generated by non-polar dispersion, P(M) is a solubility parameter generated by polar energy due to a permanent dipole moment, H(M) is a solubility parameter generated by energy within hydrogen bonds, x₁, x₂, and x₃ each represent a real number greater than zero (0), y is a real number greater than zero (0), and z is a real number greater than zero (0). In a preferred exemplary embodiment, x₁ is a real number ranging from 0.5 to 4.5, x₂ is a real number ranging from 0.2 to 2, x₃ is a real number ranging from 0.2 to 2.5, y is a real number of 0.5 to 2.5, and z is a real number of 0.1 to 0.8.

In greater detail, step 4) is carried out as shown in the following process:

```
DO I = 1, N₁′
            REP-HSP(A_{I}) = (x₁xD(A_{I})^{y}+x₂xP(A_{I})^{y}+x₃xH(A_{I})^{y})^{z}
ENDDO
DO J = 1, N₂′
            REP-HSP(B_{J}) = (x₁xD(B_{J})^{y}+x₂xP(B_{J})^{y}+x₃xH(B_{J})^{y})^{z}
ENDDO
```

In step 5), Group-Score(M) for solvent M that belongs to the population A′ or B′ is calculated according to the following equation 3;

Group-Score(M)=Funct1(REP-HSP(M))×Funct2(PC(M)) [Equation 3]

wherein Funct1(x)=γ×{ log_{β}(x)}^{α} wherein α is a real number greater than 0.5, β is a real number greater than 0 and γ is a real number greater than 0, and Funct2(x)=d^{x} or d^{-x} wherein d is a real number greater than 0.01, PC(M) is an octanol-water partition coefficient obtained by experimental measurement or theoretical calculation, or topological polar surface area obtained by theoretical calculation. In one preferred exemplary embodiment, α is a real number ranging from 0.5 to 2.5, β is 10, and γ is a real number ranging from 0 to 10⁵. In greater detail, PC(M), which is an octanol-water partition coefficient or topological polar surface area whether obtained by experimental measurement or theoretical calculation, was calculated using the ADRIANA.Code program of Molecular Networks GmbH Computerchemie in the present invention.

Step 6) is to obtain maximum and minimum values of each population are obtained from among the Group-Score (M) values calculated in step 5). In step 6), the maximum value MAX(A′) and the minimum value MIN(A′) are selected from among the Group-Score values calculated for the solvents of population A′. When population A′ is composed of a single solvent, MAX(A′)=MIN(A′). Likewise, MAX(B′) and MIN(B′) are selected from among the Group-Score values calculated for the solvents of population B′, and if only one solvent exists, MAX(B′)=MIN(B′).

Step 7) is to discriminate populations A′ and B′ to assess difference in property between populations A′ and B′ with the help of the Group-Score (M) value if δ(A′, B′)>E or δ(B′, A′)>E as measured by the following equation 4.

δ(A′,B′)=MIN(A′)−MAX(B′)

δ(B′,A′)=MIN(B′)−MAX(A′) [Equation 4]

wherein MAX(A′) and MIN(A′) represent maximum and minimum values among the Group-score values calculated for the solvents belonging to population A′, respectively, and MAX(B′) and MIN(B′) represent maximum and minimum values among the Group-Score values calculated for the solvents belonging to population B′, respectively. The condition that δ(A′,B′)>E or δ(B′,A′)>E is required for the assessment of property difference between populations A′ and B′. In Equation 4, E is not particularly limited so long as it is a real number greater than zero; however, preferably E=ε. If the condition is not satisfied, property difference between populations A′ and B′ cannot be discriminated through the Group-Score.

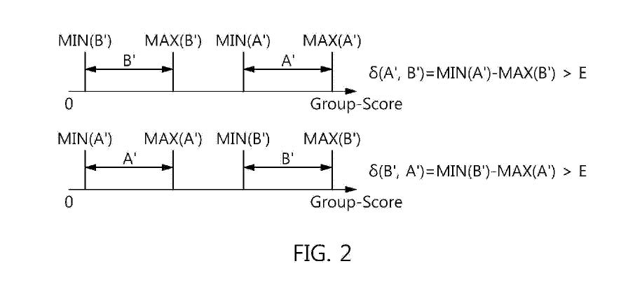

FIG. 2 is a schematic view illustrating the discrimination of populations A′ and B′ using Group-Score in accordance with an exemplary embodiment of the present invention.

In accordance with another aspect thereof, the present invention addresses a system of selecting a solvent for solution process, using the solvent selecting method of the present invention.

The solvent selecting system comprises:

a first data input module for receiving data obtained by calculating DEV-HSP (A_{I},B_{J}), which is the Hansen Solubility Parameter deviation between solvent A_{I} that amounts to the number N₁ and belongs to population A, and solvent B_{J} that amounts to the number N₂ and belongs to population B, according to the following equation 1;

a second data input module for receiving data obtained by determining which combination of the N₁×N₂ number combinations of A_{I} and B_{J} that are calculated for HSP deviation (DEV-HSP(A_{I},B_{J}) in step 1) has an HSP deviation value within the range of from zero (0) to ε (a real number greater than zero);

a third data input module for receiving data obtained by stopping the assessing process of solvent properties when none of the A_{I} and B_{J} combinations have an HSP deviation within the range defined in the second data input module, or by assigning, if otherwise, A_{I} and B_{J}, the DEV-HSP(A_{I},B_{J}) of which falls within the range, to populations A′ and B′, respectively;

a fourth data input module for receiving data obtained by calculating REP-HSP(M) for solvent M that belongs to the population A′ or B′ assigned in the third data input module according to the following equation 2;

a fifth data input module for receiving data obtained by calculating Group-Score(M) for solvent M that belongs to the population A′ or B′ assigned in the third data input module according to the following equation 3;

a sixth data input module for receiving data on maximum and minimum values of each population obtained from among the Group-Score(M) values calculated in the fifth data input module; and

an assessment module for receiving data obtained by discriminating populations A′ and B′ to assess difference in property between populations A′ and B′ with the help of the Group-Score(M) value if δ(A′,B′)>E or δ(B′,A′)>E as measured by the following equation 4:

DEV-HSP(A_{I},B_{J})=(a₁×|D(A_{I})−D(B_{J})|^{b}+a₂×|P(A_{I})−P(B_{J})|^{b}+a₃×|H(A_{I})−H(B_{J})|^{b})^{c} [Equation 1]

wherein A_{I} and B_{J} are solvents belonging to populations A and B, respectively, the HSP of solvent A_{I} is expressed as HSP=(D(A_{I}),P(A_{I}),H(A_{I})) wherein D(A_{I}) is a solubility parameter generated by non-polar dispersion, P(A_{I}) is a solubility parameter generated by polar energy due to a permanent dipole moment, H(A_{I}) is a solubility parameter generated by energy within hydrogen bonds, a₁, a₂, and a₃ each represent a real number greater than zero (0), b is a real number greater than zero (0), and c is a real number greater than zero (0);

REP-HSP(M)=(x₁×D(M)^{y}+x₂×P(M)^{y}+x₃×H(M)^{y})^{z} [Equation 2]

wherein the HSP of solvent M is expressed as HSP=(D(M), P(M), H(M)) wherein D(M) is a solubility parameter generated by non-polar dispersion, P(M) is a solubility parameter generated by polar energy due to a permanent dipole moment, H(M) is a solubility parameter generated by energy within hydrogen bonds, x₁, x₂, and x₃ each represent a real number greater than zero (0), y is a real number greater than zero (0), and z is a real number greater than zero (0);

Group-Score(M)=Funct1(REP-HSP(M))×Funct2(PC(M)) [Equation 3]

wherein Funct1(x)=γ×{ log_{β}(x)}^{α} wherein α is a real number greater than 0.5, β is a real number greater than 0 and γ is a real number greater than 0, and Funct2(x)=d^{x} or d^{-x} wherein d is a real number greater than 0.01, PC(M) is an octanol-water partition coefficient obtained by experimental measurement or theoretical calculation or topological polar surface area obtained by theoretical calculation; and

δ(A′,B′)=MIN(A′)−MAX(B′)

δ(B′,A′)=MIN(B′)−MAX(A′) [Equation 4]

wherein MAX(A′) and MIN(A′) represent maximum and minimum values among the Group-score values calculated for the solvents belonging to population A′, respectively, and MAX(B′) and MIN(B′) represent maximum and minimum values among the Group-Score values calculated for the solvents belonging to population B′, respectively.

In Equation 1, a₁ is a real number ranging from 0.5 to 4.5, a₂ is a real number ranging from 0.5 to 3, a₃ is a real number ranging from 0.5 to 2.5, b is a real number ranging from 1.0 to 2.5, and c is a real number ranging from 0.1 to 1.0 according to a preferred exemplary embodiment.

More preferably, ε is a real number ranging from 0.1 to 4.0.

In Equation 2, x₁ is a real number ranging from 0.5 to 4.5, x₂ is a real number ranging from 0.2 to 2, x₃ is a real number ranging from 0.2 to 2.5, y is a real number ranging from 0.5 to 2.5, and z is a real number ranging from 0.1 to 0.8 according to a preferred exemplary embodiment.

In Equation 3, α is a real number ranging from 0.5 to 2.5, β is 10, and γ is a real number ranging from 0 to 10⁵ according to a preferred exemplary embodiment.

In Equation 4, E=ε is preferred.

As used herein, the term “module” refers to a unit for processing at least one function or operation and can be realized by hardware, software, or a combination thereof.

### MODE FOR INVENTION

Below, the present invention will be explained in greater detail with reference to the following embodiments, it should be understood by those skilled in the art that various alternatives to the embodiments of the invention described herein may be employed in practicing the invention without departing from the spirit and scope of the invention as defined in the following claims. It is intended that the following claims define the scope of the invention and that the method within the scope of these claims and their equivalents be covered thereby.

### Comparative Example

In a specific solution process, respective solutions derived from ethanol 2-(2-propoxyethoxy) and vinyl amine), both belonging to population A, guaranteed excellent process performance whereas butyl lactate, belonging to population B′, did not.

Since the solvents of population A were very similar in HSP to the solvent of population B as shown in Table 1, it was difficult to compare properties of the solvents from one another by use of HSP alone. Hence, it was impossible to accurately discriminate solubility properties between populations A and B, which resulted in being incapable of selecting an optimal solvent similar to solvents of population A from among population B.

TABLE 1

| | D | P | H |
|---|---|---|---|
| Ethanol 2-(2-propoxyethoxy), CAS-NO: 6881-94-3 | 16.0 | 7.2 | 11.3 |
| Butyl lactate, CAS-NO: 138-22-7 | 15.8 | 6.5 | 10.2 |
| Vinyl Amine, CAS-NO: 593-67-9 | 15.7 | 7.2 | 11.8 |

### Example

Population A={ethanol 2-(2-propoxyethoxy), vinyl amine}

Population B={butyl lactate}

TABLE 2

| (Aᵢ, Bⱼ) | DEV-HSP |
|---|---|
| (Ethanol 2-(2-propoxyethoxy), Butyl lactate) | 1.36 |
| (Vinyl amine, Butyl lactate) | 1.76 |

For the calculation of DEV-HSP, a₁=4.0, a₂=1.0, a₃=1.0, b=2.0, and c=0.5 were set.

For ε=1.5, difference in Hansen solubility parameter could discriminate vinyl amine from butyl lactate, but could not allow the precise discrimination of ethanol 2-(2-propoxyethoxy) and butyl lactate. Thus, assignment of populations A′ and B′ was made as follows.

Population A′={Ethanol 2-(2-propoxyethoxy)}

Population B′={Butyl lactate}

Group-Score was calculated for populations A′ and B′ and the results are summarized in Table 3, below.

TABLE 3

| | Group-Score |
|---|---|
| Ethanol 2-(2-propoxyethoxy) | 5.11 |
| Butyl lactate | 0.36 |

In order to calculate Group-Score of Table 3, the following conditions were set:

(1) for calculation of REP-HSP, x₁=1.0, x₂=1.0, x₃=1.0, y=2.0, and z=0.5.

(2) for calculation of Funct1, α=1.0, β=10, and γ=3.0.

(3) for calculation of Funct2, PC=Octanol-Water Partition Coefficient. This partition coefficient was calculated using the ADRIANA.Code program of Molecular Networks GmbH Computerchemie.

(4) for calculation of Funct2, the d^{-x} function was used at d=10, x=PC.

Because each of populations A′ and B′ was composed of a single solvent, their maximum and minimum values were the same as follows:

Population A′: MAX(A′)=5.11 MIN(A′)=5.11

Population B′: MAX(B′)=0.36 MIN(B′)=0.36

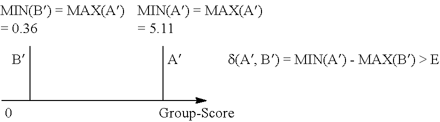

Through Group-Score, characteristics of populations A′ and B′ can be precisely discriminated. In case of E=ε=1.5, δ(A′,B′)=4.75>E. Therefore, the method of the present invention using Group-Score can discriminate solvents of populations A′ and B′ more precisely than the convention method using HSP

1. A method of selecting a solvent for a solution process, comprising:
1) calculating DEV-HSP (A_{I},B_{J}), which is the Hansen Solubility Parameter deviation between solvent A_{I} that amounts to the number N₁ and belongs to population A, and solvent B_{J} that amounts to the number N₂ and belongs to population B, according to the following equation 1;
2) determining which of the N₁×N₂ number combinations of A_{I} and B_{J} that are calculated for HSP deviation (DEV-HSP(A_{I},B_{J}) in step 1) has an HSP deviation value within the range of from zero (0) to ε (a real number greater than zero);
3) stopping the assessing process of solvent properties when none of the A_{I} and B_{J} combinations have an HSP deviation within the range defined in step 2), or if otherwise, assigning A_{I} and B_{J}, the DEV-HSP(A_{I},B_{J}) of which falls within the range, to populations A′ and B′, respectively;
4) calculating REP-HSP(M) for solvent M that belongs to the population A′ or B′ assigned in step 3) according to the following equation 2;
5) calculating Group-Score(M) for solvent M that belongs to the population A′ or B′ assigned in step 3) according to the following equation 3;
6) obtaining maximum and minimum values of each population from among the Group-Score(M) values calculated in step 5); and
7) discriminating populations A′ and B′ to assess difference in property between populations A′ and B′ with the help of the Group-Score(M) value if δ(A′,B′)>E or δ(B′,A′)>E as measured by the following equation 1:
DEV-HSP(A_{I},B_{J})=(a₁×|D(A_{I})−D(B_{J})|^{b}+a₂×|P(A_{I})−P(B_{J})|^{b}+a₃×|H(A_{I})−H(B_{J})|^{b})^{c} [Equation 1]
wherein A_{I} and B_{J} are solvents belonging to populations A and B, respectively, the HSP of solvent A_{I} is expressed as HSP=(D(A_{I}),P(A_{I}),H(A_{I})) wherein D(A_{I}) is a solubility parameter generated by non-polar dispersion, P(A_{I}) is a solubility parameter generated by polar energy due to a permanent dipole moment, H(A_{I}) is a solubility parameter generated by energy within hydrogen bonds, a₁, a₂, and a₃ each represent a real number greater than zero (0), b is a real number greater than zero (0), and c is a real number greater than zero (0);
REP-HSP(M)=(x₁×D(M)^{y}+x₂×P(M)^{y}+x₃×H(M)^{y})^{z} [Equation 2]
wherein the HSP of solvent M is expressed as HSP=(D(M), P(M), H(M)) wherein D(M) is a solubility parameter generated by non-polar dispersion, P(M) is a solubility parameter generated by polar energy due to a permanent dipole moment, H(M) is a solubility parameter generated by energy of hydrogen bonds, x₁, x₂, and x₃ each represent a real number greater than zero (0), y is a real number greater than zero (0), and z is a real number greater than zero (0);
Group-Score(M)=Funct1(REP-HSP(M))×Funct2(PC(M)) [Equation 3]
wherein Funct1(x)=γ×{ log_{β}(x)}^{α} wherein α is a real number greater than 0.5, β is a real number greater than 0 and γ is a real number greater than 0, and Funct2(x)=d^{x} or d^{-x} wherein d is a real number greater than 0.01, PC(M) is an octanol-water partition coefficient obtained by experimental measurement or theoretical calculation or topological polar surface area obtained by theoretical calculation; and
δ(A′,B′)=MIN(A′)−MAX(B′)
δ(B′,A′)=MIN(B′)−MAX(A′) [Equation 4]
wherein MAX(A′) and MIN(A′) represent maximum and minimum values among the Group-score values calculated for the solvents belonging to population A′, respectively, and MAX(B′) and MIN(B′) represent maximum and minimum values among the Group-Score values calculated for the solvents belonging to population B′, respectively.

2. The method of claim 1, wherein a₁ is a real number ranging from 0.5 to 4.5, a₂ is a real number ranging from 0.5 to 3, a₃ is a real number ranging from 0.5 to 2.5, b is a real number ranging from 1.0 to 2.5, and c is a real number ranging from 0.1 to 1.0 in Equation 1.

3. The method of claim 1, wherein c is a real number ranging from 0.1 to 4.0.

4. The method of claim 1, wherein x₁ is a real number ranging from 0.5 to 4.5, x₂ is a real number ranging from 0.2 to 2, x₃ is a real number ranging from 0.2 to 2.5, y is a real number ranging from 0.5 to 2.5, and z is a real number ranging from 0.1 to 0.8 in Equation 2.

5. The method of claim 1, wherein α is a real number ranging from 0.5 to 2.5, β is 10, γ is a real number ranging from 0 to 10⁵ in Equation 3.

6. The method of claim 1, wherein E equals ε in Equation 4.

7. A system of selecting a solvent for solution process, comprising:
a first data input module for receiving data obtained by calculating DEV-HSP (A_{I},B_{J}), which is the Hansen Solubility Parameter deviation between solvent A_{I} that amounts to the number N1 and belongs to population A, and solvent B_{J} that amounts to the number N₂ and belongs to population B, according to the following equation 1;
a second data input module for receiving data obtained by determining which combination of the N₁×N₂ number combinations of A_{I} and B_{J} that are calculated for HSP deviation (DEV-HSP(A_{I},B_{J}) in step 1) has an HSP deviation value within the range of from zero (0) to ε (a real number greater than zero);
a third data input module for receiving data obtained by stopping the assessing process of solvent properties when none of the A_{I} and B_{J} combinations have an HSP deviation within the range defined in the second data input module, or by assigning, if otherwise, A_{I} and B_{J}, the DEV-HSP(A_{I},B_{J}) of which falls within the range, to populations A′ and B′, respectively;
a fourth data input module for receiving data obtained by calculating REP-HSP(M) for solvent M that belongs to the population A′ or B, assigned in the third data input module, according to the following equation 2;
a fifth data input module for receiving data obtained by calculating Group-Score(M) for solvent M that belongs to the population A′ or B′, assigned in the third data input module, according to the following equation 3;
a sixth data input module for receiving data on maximum and minimum values of each population obtained from among the Group-Score(M) values calculated in the fifth data input module; and
an assessment module for receiving data obtained by discriminating populations A′ and B′ to assess difference in property between populations A′ and B′ with the help of the Group-Score(M) value if δ(A′,B′)>E or δ(B ‘,A’)>E as measured by the following equation 4:
DEV-HSP(A_{I},B_{J})=(a₁×|D(A_{I})−D(B_{J})|^{b}+a₂×|P(A_{I})−P(B_{J})|^{b}+a₃×|H(A_{I})−H(B_{J})|^{b})^{c} [Equation 1]
wherein A_{I} and B_{J} are solvents belonging to populations A and B, respectively, the HSP of solvent A_{I} is expressed as HSP=(D(A_{I}),P(A_{I}),H(A_{I})) wherein D(A_{I}) is a solubility parameter generated by non-polar dispersion, P(A_{I}) is a solubility parameter generated by polar energy due to a permanent dipole moment, H(A_{I}) is a solubility parameter generated by energy of hydrogen bonds, a₁, a₂, and a₃ each represent a real number greater than zero (0), b is a real number greater than zero (0), and c is a real number greater than zero (0);
REP-HSP(M)=(x₁×D(M)^{y}+x₂×P(M)^{y}+x₃×H(M)^{y})^{z} [Equation 2]
wherein the HSP of solvent M is expressed as HSP=(D(M), P(M), H(M)) wherein D(M) is a solubility parameter generated by non-polar dispersion, P(M) is a solubility parameter generated by polar energy due to a permanent dipole moment, H(M) is a solubility parameter generated by energy of hydrogen bonds, x₁, x₂, and x₃ each represent a real number greater than zero (0), y is a real number greater than zero (0), and z is a real number greater than zero (0);
Group-Score(M)=Funct1(REP-HSP(M))×Funct2(PC(M)) [Equation 3]
wherein Funct1(x)=γ×{ log_{β}(x)}^{α} wherein α is a real number greater than 0.5, β is a real number greater than 0 and γ is a real number greater than 0, and Funct2(x)=d^{x} or d^{-x} wherein d is a real number greater than 0.01, PC(M) is an octanol-water partition coefficient obtained by experimental measurement or theoretical calculation or topological polar surface area obtained by theoretical calculation; and
δ(A′,B′)=MIN(A′)−MAX(B′)
δ(B′,A′)=MIN(B′)−MAX(A′) [Equation 4]
wherein MAX(A′) and MIN(A′) represent maximum and minimum values among the Group-score values calculated for the solvents belonging to population A′, respectively, and MAX(B′) and MIN(B′) represent maximum and minimum values among the Group-Score values calculated for the solvents belonging to population B′, respectively.

8. The system of claim 7, wherein a₁ is a real number ranging from 0.5 to 4.5, a₂ is a real number ranging from 0.5 to 3, a₃ is a real number ranging from 0.5 to 2.5, b is a real number ranging from 1.0 to 2.5, and c is a real number ranging from 0.1 to 1.0 in Equation 1.

9. The method of claim 7, wherein ε is a real number ranging from 0.1 to 4.0.

10. The method of claim 7, wherein x₁ is a real number ranging from 0.5 to 4.5, x₂ is a real number ranging from 0.2 to 2, x₃ is a real number ranging from 0.2 to 2.5, y is a real number ranging from 0.5 to 2.5, and z is a real number ranging from 0.1 to 0.8 in Equation 2.

11. The system of claim 7, wherein α is a real number ranging from 0.5 to 2.5, β is 10, γ is a real number ranging from 0 to 10⁵ in Equation 3.

12. The system of claim 1, wherein E equals ε in Equation 4.
